(19) United States
(12) Patent Application Publication
(10) Pub. No.: US 2014/0056167 A1
(43) Pub. Date: Feb. 27, 2014

(54) METHOD AND SYSTEM FOR SPATIAL CHANNEL STATE INFORMATION FEEDBACK FOR MULTIPLE-INPUT-MULTIPLE-OUTPUT (MIMO)

(71) Applicants: Yifei Yuan, Livingston, NJ (US); David Huo, Newton, NJ (US)

(72) Inventors: Yifei Yuan, Livingston, NJ (US); David Huo, Newton, NJ (US)

(73) Assignee: ZTE (USA) INC., Richardson, TX (US)

(21) Appl. No.: 14/111,935

(22) PCT Filed: Apr. 18, 2012
(86) PCT No.: PCT/US12/33981

§ 371 Date: Nov. 11, 2013

Related U.S. Application Data
(60) Provisional application No. 61/477,802, filed on Apr. 21, 2011.

(51) Int. Cl. H04B 7/06; H04W 24/08; H04L 5/00

(52) U.S. Cl. CPC H04B 7/0626; H04L 5/0057; H04W 24/08
USPC 370/252; 370/329

(57) ABSTRACT

A method and system for feed-back of spatial CSI of an entire spatial channel that connects receive antennas at user equipment and multiple transmit antennas. Spatial discrimination information is provided as feed-back at the transmitter and the receiver connecting the user equipment and a cell. With the user equipment providing the transmitter and the receiver side spatial discrimination information of each sub-channel as feedback, the composite spatial CSI over multiple segments of transmit antennas can be determined. The user equipment may have one or multiple receiving antennas, and the spatial discrimination information can be subband short-term. In some embodiments, the spatial discrimination information at the receiver side is derived from the actual spatial channel while receiver implementation is taken into account. The spatial discrimination information at the transmitter and at the receiver can be can be provided as feedback using codebooks for MIMO precoding.

### BACKGROUND

1. Field of the Invention

The field of the present invention relates to providing spatial channel state information (CSI) for downlink communication of MIMO technologies, particularly when the number of transmit antennas is four or greater. Specifically, the field of the invention relates to spatial CSI feedback using multiple component CSIs, each represented by a codeword in an appropriate codebook.

2. Background of the Invention

MIMO techniques can significantly improve data throughput and transmission reliability by relying on multiple antennas at the transmitter, at the receiver, or both. Data throughput can be increased at the link level, at the system level, or at both the link level and the system level. Spatial multiplexing and beamforming have been used to improve spectral efficiency and data throughput. Spatial multiplexing directly boosts the link level throughput and the peak rate because multiple data streams are transmitted simultaneously to the same user via parallel channels. Spatial multiplexing is most useful when spatial correlation between antennas is low, both for the transmit antennas and the receive antennas. Beamforming or precoding increases the signal-to-interference-plus-noise ratio (SINR) of the channel, and thus the channel rate. Precoding refers to applying proper weights over multiple transmit antennas. Weight calculations are based on spatial CSI from either channel reciprocity or feedback.

When the number of transmit antennas is greater than the number of receive antennas, the extra spatial dimensions at the transmitter allow precoding to be carried out more effectively. For example, in frequency-division duplexing (FDD) systems where channel reciprocity does not generally hold, spatial CSI feedback is needed for the precoding. Due to overhead concern, CSI feedback cannot utilize too many bits. In general, as the number of bits increases, the quantization error decreases. Therefore, codebooks are commonly used to quantize the spatial CSI. Effective codebook design can result in efficient quantization, while minimizing the number of bits used.

Precoded MIMO can operate in two scenarios: single-user MIMO (SU-MIMO) and multi-user MIMO (MU-MIMO). In SU-MIMO, the spatially multiplexed streams are transmitted to one user and the precoding is primarily used to increase the SINR at the receiver. In MU-MIMO, data streams of multiple users share the same set of transmit antennas in the same time-frequency resource. Data decoupling can be achieved by appropriate precoding and receiver processing. The quantization error in spatial CSI feedback affects the performance of SU-MIMO and MU-MIMO quite differently, however. For SU-MIMO, the finite resolution of codebooks results in certain SINR loss in the precoding gain when the precoding does not perfectly match the spatial characteristics of the MIMO channel. Such SINR loss is almost uniform across different signal-to-noise ratio (SNR) operating points, at either low or high SNR regions. In other words, there is no loss in spatial multiplexing since the decoupling of multiple streams to the same user is solely done at the receiver, which has nothing to do with the precoding at the transmitter. However, for MU-MIMO, the quantization error directly gives rise to cross-user interference which quickly saturates the MIMO channel rate as SNR increases, as seen in FIG. 1 and described in 3GPP R1-093818, “Performance sensitivity to feedback types”, ZTE, RAN1#58bis, Miyazaki, Japan, October 2009.

When the antennas at the transmitter are correlated (e.g., beamforming antennas), codebook design problems can be significantly reduced as the MIMO channel characteristics are degraded to linear phase rotations. However, the codebook design for an uncorrelated channel is generally difficult if it is constrained by the number of bits affordable for the CSI feedback. One typical configuration of uncorrelated antennas is widely-spaced cross-pols. In a scattering environment, the spacing between the two sets (usually >4 wavelengths) ensures low correlations in between. The orthogonal polarizations (+45/−45 degrees) results in rather independent fading in each polarization direction.

N. Jindal, “MIMO broadcast channels with finite-rate feedback,” IEEE Transactions on Information Theory, vol. 52, no. 11. November 2006, pp. 5045-5060 proved that in order to achieve the full multiplexing gain in MU-MIMO, the required number of bits for CSI quantization per user should increase linearly with the operating SNR in dBs as follows

$$B = ( M - 1 ) {log}_{2} P \approx \frac{M - 1}{3} {P}_{dB} \qquad ( 1 )$$

where M is the number of transmit antennas.

In 4G wireless systems, mobile terminals are supposed to have two receive antennas, which means that for effective precoding, M should be equal to or greater than four. Even at M=4, the required number of bits needs to increase by 1 dB when the SNR operating point moves 1 dB higher. If B=2 bits at low SNR (i.e., <3 dB), B can go beyond 15 bits for high SNR (i.e., >16 dB). Design and storage of such a big codebook (2¹⁵=32798 entries) is challenging, and the codeword search would require significant baseband processing. This and other circumstances present problems and obstacles that are overcome by the methods and systems of the present invention.

### SUMMARY OF THE INVENTION

The present invention is directed to wireless communication methods and systems which provide spatial CSI for downlink communication of MIMO technologies using multiple component CSIs.

In the method, multiple transmit antennas are segmented into subsets corresponding to sub-channels. The spatial CSI of each sub-channel is measured and decomposed into component CSIs per sub-channel, a component CSI characterizes spatial discrimination information at a corresponding subset of the transmit antennas, and a component CSI characterizes spatial discrimination information at a corresponding receiver. The component CSIs per sub-channel are then used as feedback. Optionally, the component CSIs per sub-channel may be quantized using codebooks, with the quantized component CSIs per sub-channel used as feedback. Each UE provides the spatial discrimination information of the receiver and multiple segments of transmit antennas as feedback, and from this information the transmitter assembles the composite spatial CSI of the entire transmit antennas.

In the system, user equipment and segments of multiple transmit antennas establish spatial sub-channel connections having spatial CSI per sub-channel. There is included means for decomposing the spatial CSI per sub-channel into component CSIs per sub-channel, where one component CSI characterizes spatial discrimination information at the transmitter, and another component CSI characterizes spatial discrimination information at a receiver. Finally, there is means for feedback of the component CSIs per sub-channel. Optionally, means may be included for quantizing the component CSIs per sub-channel using a codebook, which then provides the quantized component CSIs as feedback. Further, means for determining composite spatial CSI corresponding to the multiple antennas may be included.

Additional aspects and advantages of the improvements will appear from the description of the preferred embodiment.

### BRIEF DESCRIPTION OF THE FIGURES

Embodiments of the present invention are illustrated by way of the accompanying drawings.

FIG. 1 shows the performance sensitivity of precoded MIMO to CSI feedback.

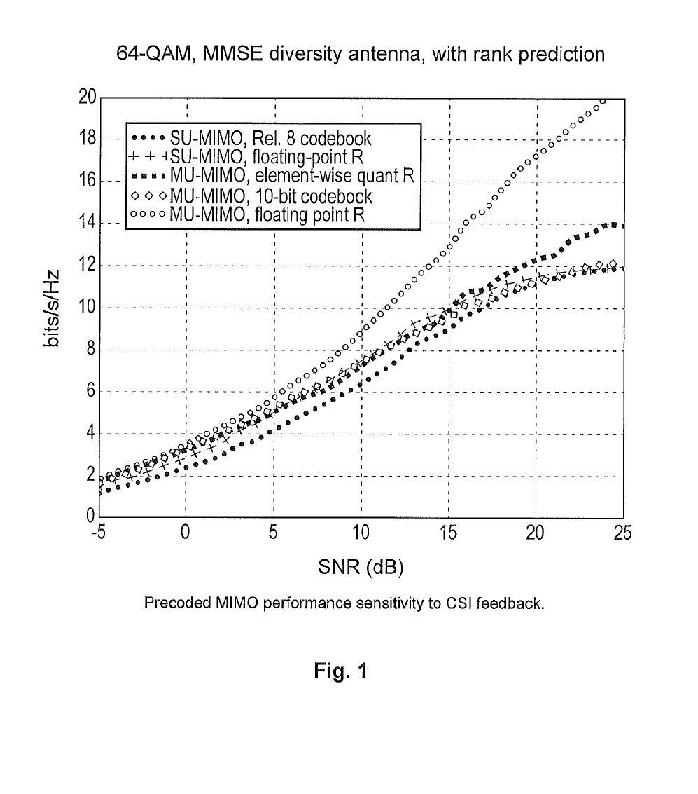

FIG. 2 is a block diagram of an example of spatial CSI feedback for downlink MIMO.

FIG. 3 illustrates an example of transmit antenna segmentation.

### DETAILED DESCRIPTION OF THE INVENTION

The method and system described below provide an efficient way to accurately feedback spatial CSI for uncorrelated MIMO channels, particularly when the number of transmit antennas is equal to or greater than four.

Spatial discrimination information of each sub-channel of MIMO is provided as feedback at both the multi-antenna transmitter and the multi-antenna receiver, connecting the UE and one segment of transmit antennas. With the UE the transmitter (in multiple segments) and the receiver side spatial discrimination information of each cell-UE connection as feedback, the transmitter can determine the composite spatial CSI over transmit antennas of entire transmission points. This technique is applicable to mobile terminals with single or multiple receiving antennas. The spatial discrimination information is primarily subband short-term.

The spatial discrimination information at the receiver side for each segment of transmit antennas can be derived directly from the spatial channel (explicit feedback, e.g., singular value decomposition) or by taking into account receiver implementation (implicit feedback). Implicit feedback assumes certain receiver processing, and usually takes the form of precoding matrix indicator (PMI) or the enhanced versions. Explicit feedback attempts to “objectively” capture the spatial channel characteristics without taking into account the receiver processing. The spatial channel is measured from the reference channels for channel state information (CSI-RS). CSI-RS is configured by higher layers.

The spatial discrimination information at each segment of the transmit antennas and at the receive antennas is provided as feedback using codebooks. Codebooks of earlier LTE releases, e.g., Rel-8/9/10, can be reused. SNR-related information such as eigenvalues of the spatial channel can also be provided as feedback using Rel-8/9/10 CQI or the enhancements.

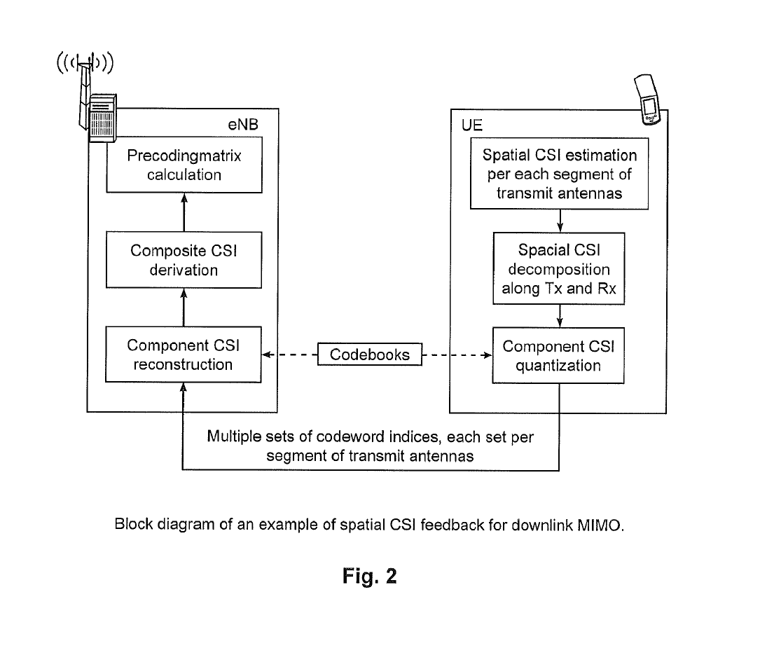

The block diagram of FIG. 2 illustrates an example of a feedback setup of the present invention. There are two major components: eNB and UE. It should be understood that the transmit antennas of eNB can reside in different geographic locations and have different polarizations.

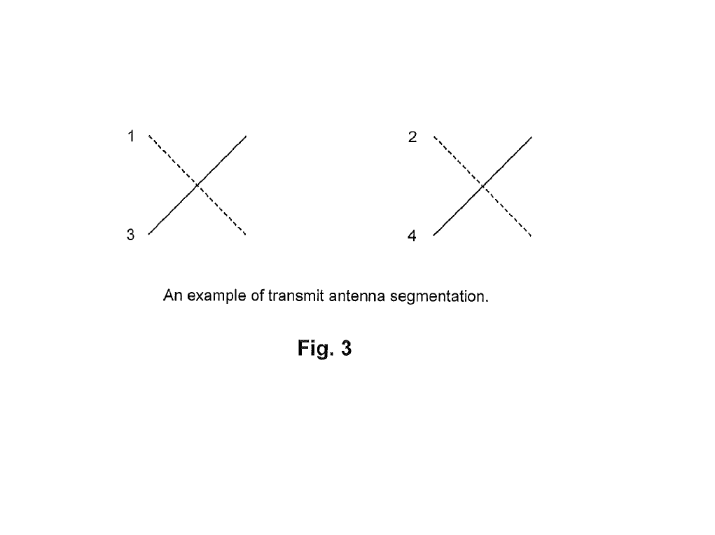

Transmit antennas are segmented into multiple subsets. FIG. 3 illustrates an example of how widely spaced cross-polarization antennas (a total of four elements) are segmented into two subsets: elements 1 and 2 comprise two +45 degree polarization antennas far apart, while elements 3 and 4 comprise two −45 degree polarization antennas far apart. Assuming the mobile terminal has two receive antennas, the four-by-two MIMO channel H is segmented as

$$H = [ \begin{matrix}{H}_{1} \\ {H}_{2}\end{matrix} ] = [ \begin{matrix}{h}_{11} & {h}_{12} \\ {h}_{21} & {h}_{22} \\ {h}_{31} & {h}_{32} \\ {h}_{41} & {h}_{42}\end{matrix} ] \qquad ( 2 )$$

where H₁ and H₂ represent the two sub-channels corresponding to +45 degree and −45 degree polarization antennas, respectively. The first subscripts 1 through 4 of “h” in (2) are the indices of the transmit antennas, while the second subscripts 1 through 2 of “h” in (2) are the indices of the receive antennas.

Each segment, “H₁” or “H₂”, is measured by way of CSI-RS. For each sub-channel (“H₁” or “H₂”) the CSI decomposition is performed by separating the transmitter-side and receiver-side spatial discriminations, each being quantized via a codebook. That is, for each sub-channel, there is a codebook index for transmitter-side spatial discrimination, and another codebook index for receiver-side spatial discrimination.

The CSI decomposition can be described in terms of a singular value decomposition (SVD) as follows:

$$\begin{matrix}{H}_{1} = [ \begin{matrix}{h}_{11} & {h}_{12} \\ {h}_{21} & {h}_{22}\end{matrix} ] = [ \begin{matrix}{v}_{11} & {v}_{12} \\ {v}_{21} & {v}_{22}\end{matrix} ] [ \begin{matrix}{λ}_{11} & 0 \\ 0 & {λ}_{22}\end{matrix} ] [ \begin{matrix}{u}_{11} & {u}_{12} \\ {u}_{21} & {u}_{22}\end{matrix} ] = {V}_{1} {Λ}_{1} {U}_{1} & ( 3 ) \\ {H}_{2} = [ \begin{matrix}{h}_{31} & {h}_{32} \\ {h}_{41} & {h}_{42}\end{matrix} ] = [ \begin{matrix}{v}_{31} & {v}_{32} \\ {v}_{41} & {v}_{42}\end{matrix} ] [ \begin{matrix}{λ}_{33} & 0 \\ 0 & {λ}_{44}\end{matrix} ] [ \begin{matrix}{u}_{31} & {u}_{32} \\ {u}_{41} & {u}_{42}\end{matrix} ] = {V}_{2} {Λ}_{2} {U}_{2} & ( 4 )\end{matrix}$$

Matrices V₁ and V₂ represent the transmitter side spatial discriminations, while U₁ and U₂ represent the receiver side spatial discriminations. The SVD helps to eliminate very weak eigenmodes, thus reducing the signaling overhead compared to providing the spatial channel matrix directly as feedback.

While the SVD is an efficient way to capture the spatial CSI, such “explicit” feedback does not consider the receiver implementation which can be different from what information theory would predict for optimum receiver. Essentially, the SVD assumes:
1. Perfect knowledge of spatial CSI at the transmitter so that the precoding can be carried to maximize the signal power and minimize the cross-channel/user interference;
2. Joint decoder with perfect demodulation and channel coding at the receiver so that the MIMO channel rate can be rewritten as the sum rate of each eigenmode of the spatial channel.

The spatial discrimination characteristics of the receiver can be determined by simply carrying out SVD on “H₁” or “H₂”; or, alternatively, by other methods and means known to those skilled in the art. For example, with a single codeword minimum mean squared error (MMSE) linear receiver, the spatial discriminator, e.g., the MMSE spatial filter of a two-by-two matrix, takes a different form than the “U” matrix.

While embodiments of the methods and systems have been shown and described, it will be apparent to those skilled in the art that many more modifications are possible without departing from the inventive concepts herein. The invention, therefore, is not to be restricted except in the spirit of the following claims.

What is claimed is:

1. A feedback method for spatial CSI of one or more spatial channels, the spatial channels connecting a UE and one or more cells, the method comprising:
segmenting a plurality of transmit antennas into a plurality of subsets, each of the subsets corresponding to a sub-channel;
measuring spatial CSI of each sub-channel;
decomposing the spatial CSI per sub-channel, resulting in at least two component CSIs per sub-channel, the first component CSI per sub-channel characterizing spatial discrimination information at a corresponding subset of the transmit antennas, and the second component CSI per sub-channel characterizing spatial discrimination information at a corresponding receiver; and
providing the component CSIs per sub-channel as feedback.

2. The method of claim 1, wherein the component CSIs per sub-channel are represented as one of a vector or a matrix.

3. The method of claim 1, wherein the decomposition comprises matrix multiplication.

4. The method of claim 1, further comprising:
quantizing the at least two component CSIs per sub-channel using at least one codebook; and
providing the quantized component CSIs per sub-channe as the feedback.

5. The method of claim 4, wherein the at least two corresponding indices are short-term subband.

6. The method of claim 1, further comprising:
deriving spatial CSIs per sub-channel while accounting for corresponding receiver implementation.

7. The method of claim 6, wherein the derivation comprises singular value decomposition.

8. The method of claim 1, wherein providing the component CSIs per sub-channel as feedback comprises using one or more codebooks for MIMO precoding.

9. The method of claim 1, further comprising determining composite spatial CSI by using the component CSIs per sub-channel.

10. A feedback system for spatial channel state information of spatial channels connecting UEs and multiple transmit antennas, the system comprising;
one or more UEs and one or more segments of multiple transmit antennas of a transmitter configured to establish one or more spatial sub-channel connections between the one or more UEs and the one or more segments of multiple transmit antennas, wherein spatial CSI per sub-channel corresponds to the spatial sub-channel connections;
means for decomposing the spatial CSI per sub-channel into at least two component CSIs per sub-channel, wherein the first component CSI characterizes spatial discrimination information at the transmitter, and the second component CSI characterizes spatial discrimination information at a receiver; and
means for providing the at least two component CSIs per sub-channel as feedback.

11. The system of claim 10 further comprising means for determining composite spatial CSI corresponding to the multiple antennas.

12. The system of claim 10, further comprising means for representing the component CSIs per sub-channel as a vector or a matrix.

13. The system of claim 10, wherein the means for decomposing is configured for matrix multiplication.

14. The system of claim 10, further comprising:
means for quantizing the at least two component CSIs per sub-channel using at least one codebook; and
means for providing the quantized component CSIs per sub-channel as the feedback.

15. The system of claim 14, wherein the at least two corresponding indices per sub-channel are short-term subband.

16. The system of claim 10, further comprising means for deriving the spatial CSI per sub-chennel while accounting for receiver implementation.

17. The system of claim 16, wherein the means for derivation is configured for singular value decomposition.

18. The system of claim 10, wherein the means for providing the quantized component CSIs per sub-channel as feedback is configured to use one or more codebooks for MIMO precoding.
